(19) United States
(12) Patent Application Publication
(10) Pub. No.: US 2014/0127389 A1
(43) Pub. Date: May 8, 2014

(54) METHOD OF MANUFACTURING MOULDABLE CHOCOLATE

(71) Applicant: Stephen Lennie, Bangor (GB)

(72) Inventor: Stephen Lennie, Bangor (GB)

(21) Appl. No.: 14/126,600

(22) PCT Filed: Jun. 15, 2012
(86) PCT No.: PCT/EP2012/002546

§ 371 Date: Dec. 16, 2013

(30) Foreign Application Priority Data
Jun. 17, 2011 (GB) 1110238.1

(51) Int. Cl. A23G 1/00; B65B 3/04

(52) U.S. Cl. CPC A23G 1/0066; B65B 3/04
USPC 426/631; 53/127

(57) ABSTRACT

A method of manufacturing mouldable chocolate, the method comprising the steps of placing predetermined amounts of chocolate and glucose syrup in predetermined proportions into a plurality of individual packets and heating and subsequently cooling the packets in accordance with a predetermined thermal profile.

This invention relates to a method of manufacturing mouldable chocolate.

Mouldable chocolate, used for example for decorating cakes, is chocolate that is soft and pliable at room temperature. Traditionally, mouldable chocolate is made by mixing chocolate with glucose syrup. Glucose syrup can be used as a sweetener in chocolate. It also has a high water content which affects the rheological or flow properties of the chocolate.

Chocolate is normally immiscible with water and other aqueous solutions. In order to mix chocolate and glucose syrup is necessary to melt the chocolate and mix it thoroughly with the syrup while the chocolate is still molten. This is normally achieved by melting chocolate over boiling water or in a microwave oven (taking care not to increase the chocolate over 37.7° C. or 100° F.) and stirring the melted chocolate, adding glucose syrup to the heated chocolate and mixing the chocolate and syrup to an even consistency before pouring the mixture on a waxed paper sheet and allowing to slowly set and stiffen overnight.

This process is time consuming and prone to errors should the chocolate be overheated or cooled too quickly, spoiling the quality of the finished product and/or preventing the syrup and chocolate from mixing correctly. Furthermore, such process is not generally suitable for producing mouldable chocolate on a large scale.

An object of the present invention is to provide an improved method of manufacturing mouldable chocolate which overcomes these problems.

The present invention provides a method of manufacturing mouldable chocolate, the method comprising the steps of placing predetermined amounts of chocolate and glucose syrup in predetermined proportions into a plurality of individual packets and heating and subsequently cooling the packets in accordance with a predetermined thermal profile.

Preferably air is removed from said individual packets before the packets are sealed prior to said heating and cooling steps.

Preferably said plurality of packets are agitated during at least a portion of said heating and cooling steps to mix the chocolate and glucose syrup. Such agitation may be achieved by tumbling the packets in a rotating drum.

Preferably said predetermined thermal profile is selected to be suited to the particular composition to be manufactured. Said predetermined thermal profile may be adjusted depending upon the type of chocolate being used.

Preferably, said heating comprises stabilizing said composition at at least one elevated temperature prior to said cooling.

Preferably said thermal profile comprises raising the temperature of the packets to a first elevated temperature for a first predetermined period and lowering the temperature of the packets to a second elevated temperature, lower than said first elevated temperature, for a second predetermined period. Said thermal profile may further comprise allowing the packets to cool to ambient temperature for a third predetermined period of time. Optionally said thermal profile may further comprise raising the temperature of the packets to a third elevated temperature for a further predetermined period of time.

Preferably, the method comprises transferring said packets to one of at least one temperature-controlled chambers, the temperature of said at least one chamber being controlled in accordance with at least one predetermined thermal profile selected to suit the composition contained in said packets to ensure proper mixing of the chocolate and syrup.

Said method may comprise the further step of removing the composition from the packets and mechanically working the composition to soften, form and divide the composition into usable portions. Said step of mechanically working the composition may take place in a screw conveyor or extrusion device, preferably in a double screw device having intermeshing rotating screws.

The present invention further comprises an apparatus for manufacturing mouldable chocolate comprising predetermined amounts of chocolate and glucose syrup in predetermined proportions in a plurality of sealed individual packets, the apparatus comprising: a rotatable drum having at least one chamber arranged to receive said packets, a temperature sensor operable to measure the temperature of said chamber, a convector operable to supply heated air to said chamber, and a controller operably connected to said sensor and said convector to control the temperature of said heated air in accordance with a thermal profile of said composition.

In one embodiment, said drum is partitioned to define a plurality of separate chambers, each chamber having a temperature sensor operable to measure the temperature of said chamber and separate heating means for controlling the temperature of air supplied to the chamber to control the temperature within said chamber in accordance with a predetermined thermal profile selected in accordance with a temperature requirement of the composition of each packet to be tempered in the chamber to maintain the composition at a desired consistency. Preferably said drum is partitioned to define a plurality of axially spaced chambers.

Preferably the or each chamber is provided with an access door permitting loading of the or each chamber with said individual packets and subsequent removal of the packets.

Preferably, said apparatus comprises a motor operably connected to said drum and controlled by said controller to selectively drive said drum in both directions.

Preferably, said rotatable drum is connected to said motor via a drive belt.

A fan may operably connected to said motor, or other drive means, for supplying air to said at least one chamber. Said fan may be controllable independently of said motor and/or of said heating means by any suitable control means. Said heating means may be controllable independently of said motor and/or of said fan by any suitable control means.

Preferably, said drive belt includes a self-tensioning mechanism.

Said apparatus may be of the type disclosed in WO2008/119530, incorporated herein by reference.

An embodiment of the invention will now be described, by way of example only.

In a method of manufacturing mouldable chocolate in accordance with an embodiment of (preferably in the form of plastic bags), and predetermined amounts of glucose syrup are added and air is expelled from the pouches before they are heat sealed.

The pouches are placed in a rotating drum and each pouch is heated and stirred independently within said rotating chamber in accordance with a predetermined temperature profile selected to suit the particular composition of the mixture within the pouches.

The melting and mixing temperatures in accordance with said thermal profile are specific to the type of chocolate being used (e.g. Dark, White or Milk).

The selected thermal profile increases the temperature to a given point and the products are stirred continuously by tumbling within the drum whilst the temperature within the drum is stabilised for a predetermined period of time. The selected thermal profile ensures that the contents of the bag are simultaneously heated and stirred until the chocolate melts and mixes with the glucose syrup.

The temperature is then lowered to a new set point and the pouches are continuously stirred until the mixture contained therein is completely combined. The glucose syrup which has also been heated to the same temperature as the chocolate can now combine to become a single homogeneous mixture.

The pouches are subsequently cooled to ambient temperature to allow the mixture therein to set. Such cooling stage may last around 8 hours, but may be longer or shorter.

Once the mixture has set, the pouches may be heated for preferably at least a further 3 hours to an elevated temperature, again product specific.

Now the product may be decanted from the pouches and may be broken and forced through rotating interlocking double screws to thoroughly knead the product to soften, form and divide the product into usable portions.

In one embodiment for the manufacture of mouldable chocolate using a milk chocolate base the following thermal profile was followed:

Typical Milk Chocolate profile for (10 × 1034 g) packs of
product per chamber.

| Step | Air Temp | Time | Agitation | Product Temp |
|---|---|---|---|---|
| 1. | 45 Deg C. | 10 mins | Rotating | (Pre-heat) |
| 2. | 35 Deg C. | 7 mins | Rotating | 38 Deg C. |
| 3. | 25 Deg C. | 3 mins | Rotating | 30 Deg C. |
| 4. | 16 Deg C. | 12 hours | None | 16 Deg C. |
| 5. | 25 Deg C. | 3 hours | None | 22 Deg C. |

These times and temperatures may be adjusted according to volume and type of chocolate used.

The invention is not limited to the embodiment(s) described herein but can be amended or modified without departing from the scope of the present invention.

1. A method of manufacturing mouldable chocolate, the method comprising the steps of placing predetermined amounts of chocolate and glucose syrup in predetermined proportions into a plurality of individual packets and heating and subsequently cooling the packets in accordance with a predetermined thermal profile.

2. The method of claim 1, comprising the step of removing air from the individual packets before the packets are sealed prior to the heating and cooling steps.

3. The method of claim 1, comprising the step of agitating the plurality of packets during at least a portion of the heating and cooling steps to mix the chocolate and glucose syrup.

4. The method of claim 3, wherein the agitation is achieved by tumbling the packets in a rotating drum.

5. The method of claim 1, wherein the predetermined thermal profile is selected to be suited to the particular composition to be manufactured, the predetermined thermal profile being adjusted depending upon the type of chocolate being used.

6. The method of claim 1, wherein the heating step comprises stabilizing the composition at at least one elevated temperature prior to the cooling step.

7. The method of claim 1, wherein the thermal profile comprises raising the temperature of the packets to a first elevated temperature for a first predetermined period and lowering the temperature of the packets to a second elevated temperature, lower than the first elevated temperature, for a second predetermined period.

8. The method of claim 7, wherein the thermal profile further comprises allowing the packets to cool to ambient temperature for a third predetermined period of time.

9. The method of claim 7, wherein the thermal profile further comprises raising the temperature of the packets to a third elevated temperature for a further predetermined period of time.

10. The method of claim 1, comprising transferring the packets to one of at least one temperature-controlled chambers, the temperature of the at least one chamber being controlled in accordance with at least one predetermined thermal profile selected to suit the composition contained in the packets to ensure proper mixing of the chocolate and syrup.

11. The method of claim 1, further comprising the step of removing the composition from the packets and mechanically working the composition to soften, form and divide the composition into usable portions.

12. The method of claim 11, wherein the step of mechanically working the composition takes place in a screw conveyor or extrusion device.

13. The method of claim 12, wherein the step of mechanically working the composition takes place in a double screw device having intermeshing rotating screws.

14. An apparatus for manufacturing mouldable chocolate comprising predetermined amounts of chocolate and glucose syrup in predetermined proportions in a plurality of sealed individual packets, the apparatus comprising: a rotatable drum having at least one chamber arranged to receive the packets, a temperature sensor operable to measure the temperature of the chamber, a convector operable to supply heated air to the chamber, and a controller operably connected to the sensor and the convector to control the temperature of the heated air in accordance with a thermal profile of the composition.

15. The apparatus of claim 14, wherein the drum is partitioned to define a plurality of separate chambers, each chamber having a temperature sensor operable to measure the temperature of the chamber and separate heating device for controlling the temperature of air supplied to the chamber to control the temperature within the chamber in accordance with a predetermined thermal profile selected in accordance with a temperature requirement of the composition of each packet to be tempered in the chamber to maintain the composition at a desired consistency.

16. The apparatus of claim 15, wherein the drum is partitioned to define a plurality of axially spaced chambers.

17. The apparatus of claim 14, wherein the or each chamber is provided with an access door permitting loading of the or each chamber with the individual packets and subsequent removal of the packets.

18. The apparatus of claim 14, comprising a motor operably connected to the drum and controlled by the controller to selectively drive the drum in both directions.

19. The apparatus of claim 18, wherein the rotatable drum is connected to the motor via a drive belt.

20. The apparatus of claim 18, wherein a fan is operably connected to the motor, or other drive device, for supplying air to the at least one chamber.

21. The apparatus of claim 20, wherein the fan is controllable independently of the motor and/or of the heating device by a control device.

22. The apparatus of claim 20, wherein the heating device is controllable independently of the motor and/or of the fan by a control device.
